(19) United States
(12) Patent Application Publication
(10) Pub. No.: US 2012/0153204 A1
(43) Pub. Date: Jun. 21, 2012

(54) ARRANGEMENT FOR MOVING THE SPINDLE OF A VALVE, AND A VALVE

(76) Inventors: Göran Sundholm, Tuusula (FI); Harry Metzger, Kerava (FI)

(21) Appl. No.: 13/391,017

(22) PCT Filed: Aug. 17, 2010
(86) PCT No.: PCT/FI2010/050644

§ 371 Date: Feb. 17, 2012

(30) Foreign Application Priority Data
Aug. 2, 2009 (FI) 20095858

(51) Int. Cl. F16K 31/50

(52) U.S. Cl. 251/267

(57) ABSTRACT

A spindle of a valve includes a frame part, with a bore having a valve spindle arranged in a movable manner within the bore. The valve spindle is fitted to be moved with an adjustment member that is connected to the frame part and can be rotated with respect to the frame part. The adjustment member includes an aperture, through which the valve spindle extends. The adjustment member includes an internal thread part that is fitted to the counterthreads of the spindle part wherein when the adjustment member is rotated the valve spindle moves along with the rise of the threads. Rolling members are fitted between the frame part and the adjustment member. The rolling members are positioned in an aperture or embedded into the first frame part or the adjustment member. A rolling groove is provided in the second frame part or the adjustment member.

### BACKGROUND OF THE INVENTION

The object of the invention is an arrangement for moving the spindle of a valve as defined in the preamble of claim 1.

Another object of the invention is a valve as defined in the preamble of claim 10.

Various valves are known in the art, e.g. fill valves, in which the valve is opened or closed manually by rotating from an adjustment means, typically from a nut, with a tool, such as an adjustable spanner or corresponding. The adjustment means comprises internal threads and the spindle of the valve comprises external threads, into which the internal threads of the adjustment means fit. By rotating the adjustment means the spindle of the valve moves linearly, typically opening or closing the valve, based on the direction of rotation of the adjustment means. The adjustment means is connected to the valve frame to stay typically in its position in the linear direction of movement of the spindle of the valve. Prior art includes solutions, in which a retaining ring, fixed protrusions or corresponding are disposed between the adjustment means and the valve frame, in which case the adjustment means is arranged to comprise at least two parts that are connected to each other during installation. These parts are connected to each other e.g. by welding. This type of solution is presented in FIG. 4 and in publication South Bend Controls, Inc Bulletin AV-503 http://www.sbcontrols.com/products/AV-503 (Fill&Vent).PDF (downloaded on 19 Aug. 2009).

A problem in prior art is that, among other things, when closing the valve the adjustment means can be turned to be so tight that the adjustment means can get jammed owing to a possible deformation of the retaining ring and of the adjustment means. Accurate tolerances can therefore also change, which is a drawback to the operation of the valve. In addition, the assembling of the valve structure requires welding.

The purpose of this invention is to achieve a new type of solution, by means of which the drawbacks of prior-art solutions can be avoided. Another aim is to achieve a solution, by means of which the valve can be formed to be more operationally reliable in its structure than earlier. Yet another aim is to achieve a solution that facilitates the opening and closing of the valve. Further, another aim is to achieve a solution, by means of which the assembly of the valve can be performed without any particular deformation of parts or without any special connection techniques, such as welding or corresponding.

### BRIEF DESCRIPTION OF THE INVENTION

The solution according to the invention is based on a concept, in which rolling means, more particularly balls, are fitted to be used between the adjustment means and the valve frame, which rolling means, on the other hand, connect the frame and the adjustment means together and facilitate the rotation of the adjustment means.

The arrangement for moving a valve according to the invention is mainly characterized by the fact that rolling means are fitted between the frame part and adjustment means and, for the rolling means, an aperture or embedding into the first either frame part or adjustment means, and a rolling groove into the second either frame part or adjustment means.

The arrangement for moving according to the invention is also characterized by what is stated in claims 2-9.

The valve according to the invention is characterized by the fact that some arrangement for moving the spindle of the valve according to any of claims 1-9 is used in it.

The solution according to the invention has a number of significant advantages. By arranging the connection between the adjustment means and frame part using rolling means, a reliable solution for moving the spindle of a valve is achieved. By means of the solution the drawbacks of prior-art solutions can be avoided, in which case the moving mechanism remains sensitive and does not jam. Additionally, when assembling the mechanism there is no need to use welding or methods that deform parts. The arrangement for moving is suited to be used in connection with a large number of valves. Typical applications are different fill and drain valves, e.g. in connection with the pressure chambers of gaseous media.

### BRIEF DESCRIPTION OF THE FIGURES

In the following, the invention will be described in more detail by the aid of an example with reference to the attached drawing, wherein

FIG. 1 presents an embodiment of a partially sectioned apparatus according to the invention, with the spindle of the valve in the first position,

FIG. 2 presents an embodiment of a partially sectioned apparatus according to the invention, with the spindle of the valve in the second position,

FIG. 3 presents one embodiment of a valve according to the invention,

FIG. 4 presents an embodiment of a prior-art apparatus, sectioned.

### DETAILED DESCRIPTION OF THE INVENTION

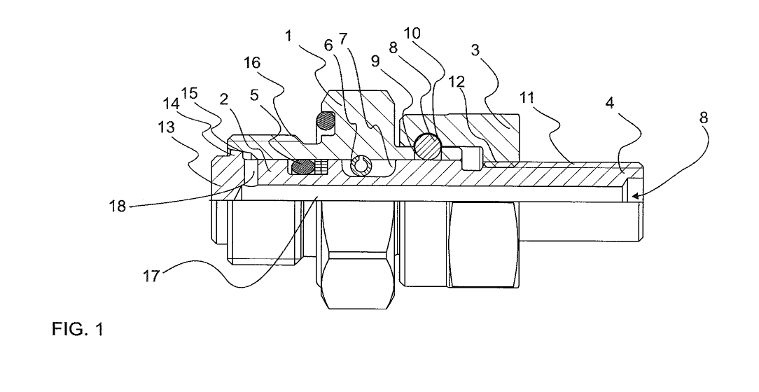

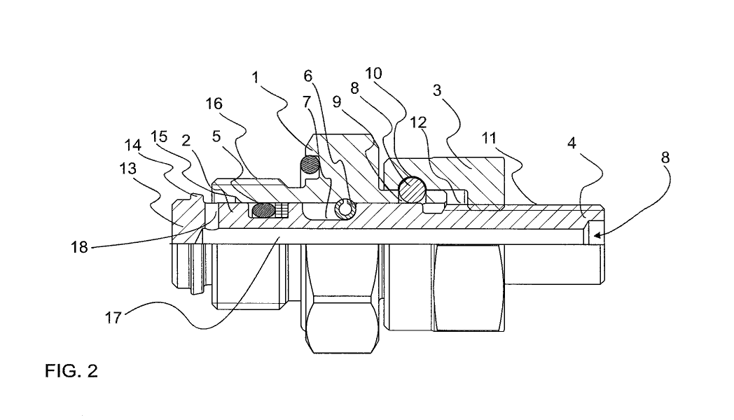

FIGS. 1 and 2 present an arrangement for moving the spindle of a valve, and a partially sectioned valve, according to the invention. The valve comprises a frame part 1 that contains a bore that extends through the frame part from the first side to the second side of the frame part. The spindle 2 of the valve is arranged in a movable manner into the bore of the frame part. The valve spindle 2 comprises a pathway 17 of the medium, which pathway leads from the inlet 8 at the first end towards the second end 13 of the valve spindle. In the embodiment according to the figure, the pathway 17 of the medium is a bore in the longitudinal direction of the valve spindle 2. A second section 18 of the pathway of the medium is formed from the proximity of the final end of the bore to the first section of the pathway 17 of the medium, which second section is in the transverse direction with respect to the longitudinal direction of the valve spindle and extends from the first pathway through the side surface of the valve spindle. In the embodiment of the figure the second end 13 of the valve spindle comprises a sealing surface 14 that is tightly fitted against the counter surface 15 of the valve frame 1 when the valve is closed. In the embodiment of the figure the counter surface 15 is conical, in which case the cone becomes greater towards the outer surface of the frame part. When the valve spindle 2 moves from the first position (closed-position) presented in FIG. 1 towards the position (open-position) according to FIG. 2, an aperture is formed between the sealing surface 14 of the valve spindle 2 and the counter surface 15 of the frame 1, as presented in the situation of FIG. 2. In this case the medium can pass through the pathway 17,18 of the medium of the valve.

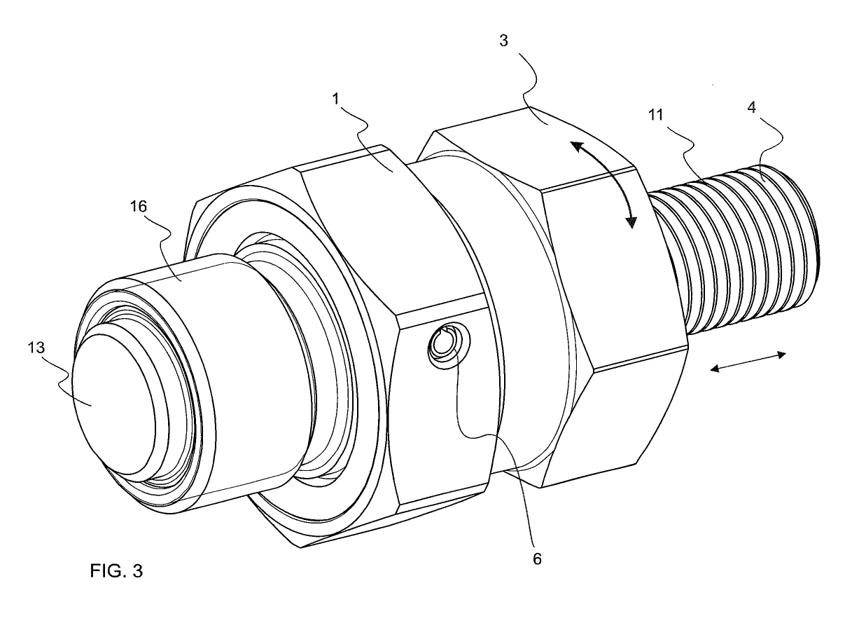

In the embodiment of FIGS. 1-3 the valve spindle 2 is fitted to be moved by means of an adjustment means 3. The adjustment means 3 comprises an aperture, through which the valve spindle 2 extends. The adjustment means 3 is connected to the frame part 1 and can be rotated in relation to the frame part. The adjustment means 3 comprises an internal threaded part 12 that is fitted to the counterthreads 11 of the valve spindle 2 such that when the adjustment means 3 is rotated the valve spindle 2 moves along with the rise of the threads.

The adjustment means 3 can be provided with surfaces formed for a torque tool, e.g. for fitting an adjustable spanner or corresponding, for rotating the adjustment means.

The rotational movement of the adjustment means can thus be changed to a linear movement of the valve spindle via a screw transmission. A transverse aperture is arranged in the frame part with respect to the longitudinal direction of the valve spindle 2, into which aperture a limiting means, such as a cotter pin 6, is arranged. A slot or embedding 7 is, for its part, formed in the spindle part 2 as a detent surface to the cotter pin 6. In this way the cotter pin prevents the valve spindle from turning as the adjustment means is rotated. On the other hand, the linear movement of the valve spindle can be limited with the length of the slot or embedding 7 in the longitudinal direction of the valve spindle.

In the solution according to the figures the valve spindle is arranged in a sealed manner with the frame part. A groove is arranged in the spindle, which groove comprises a sealing means 5.

In the solution according to the figure the frame part 1 comprises a thread part 16, with which the valve can be arranged to the desired fixing object, such as e.g. to the counterthreads of an aperture arranged in the wall of a reservoir.

The invention thus relates to an arrangement for moving of a valve spindle in a valve, which valve comprises a frame part 1, which contains a bore that extends through the frame part from the first side to the second side of the frame part, into which bore a valve spindle 2 is arranged in a movable manner, which valve spindle is fitted to be moved by an adjustment means 3 that is connected to the frame part 1 and can be rotated with respect to the frame part, which adjustment means 3 comprises an aperture, through which the valve spindle extends, in which case the adjustment means 3 comprises an internal thread part 12 that is fitted to the counterthreads 11 of the spindle part such that when the adjustment means 3 is rotated the valve spindle 2 moves along with the rise of the threads.

In the invention, rolling means 8 are fitted between the frame part 1 and the adjustment means 3 and, for the rolling means, an aperture 9 or embedding into the first frame part or adjustment means, and a rolling groove 10 into the second either frame part or adjustment means.

According to one preferred embodiment, the rolling means 8 are spherical in shape.

According to another embodiment, the rolling means 8 are cylindrically-shaped or barrel-shaped.

According to one preferred embodiment, the rolling means 8 are balls.

According to one preferred embodiment, a rolling groove 10, more particularly a ball groove, is arranged into the adjustment means 3.

Correspondingly, an aperture 9 or embedding is arranged into the frame part 1 for each rolling means 8.

Typically when the rolling means are spherical in shape, the aperture 9 arranged into the frame part 1 is round in its cross-section, more particularly an aperture formed by drilling.

According to one preferred embodiment, the aperture 9 extends from the outer surface of the frame part 1 to the inner surface of the frame part.

According to one preferred embodiment, the rolling means 8 extends from the outer surface of the valve spindle 2 through the aperture 9 of the frame part to the rolling groove 10 of the adjustment means 3, when the arrangement for moving is in the operating position.

The invention also relates to a valve, which comprises an arrangement for moving the spindle of the valve according to any of claims 1-9.

Rolling means 8 are arranged at a distance from each other consecutively onto a rim, most preferably between the frame part 1 and the valve spindle 2, into the apertures 9 formed in the adjustment means 3. The shape of the apertures is fitted according to the shape of the rolling means such that the rolling means can roll between the adjustment means 3 and the valve spindle 2, in the space of the aperture 9 of the frame part 1, when the adjustment means is rotated.

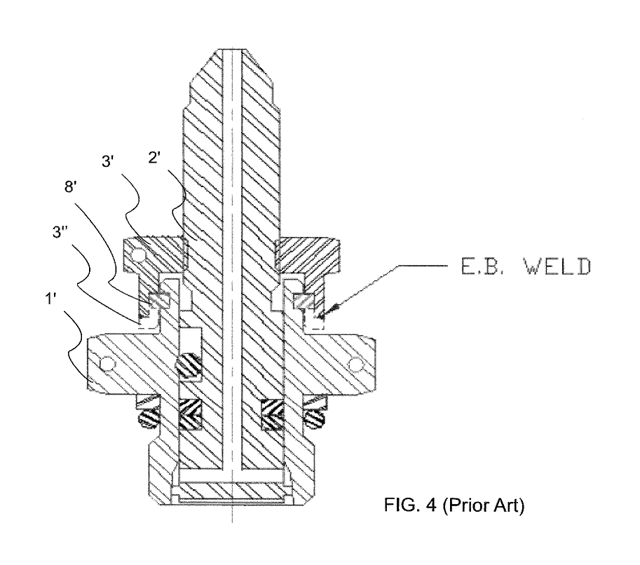

FIG. 4 presents a prior-art valve and an arrangement for moving its spindle, which adjustment means 3′ comprises internal threads and the valve spindle 2′ comprises external threads, into which the internal threads of the adjustment means fit. By rotating the adjustment means 3′ the valve spindle moves linearly, typically opening or closing the valve, based on the direction of rotation of the adjustment means. The adjustment means is connected to the valve frame 1′ to stay typically in its position in the linear direction of movement of the valve spindle. Between the adjustment means and the valve frame is a retaining ring 8′. The adjustment means is arranged to comprise at least two parts 3′, 3″, which are connected to each other during installation. These parts are connected to each other e.g. by welding. In FIG. 4 the welding is marked with a marking E.B. Weld (electron-beam welding). This type of solution is presented in FIG. 4 and in publication South Bend Controls, Inc Bulletin AV-503 http://www.sbcontrols.com/products/AV-503(Fill&Vent).PDF (downloaded on 19 Aug. 2009).

It is obvious to the person skilled in the art that the invention is not limited to the embodiments presented above, but that it can be varied within the scope of the claims presented below. The characteristic features possibly presented in the description in conjunction with other characteristic features can, if necessary, also be used separately to each other.

1. Arrangement for moving the spindle of a valve in a valve, which valve comprises a frame part (1), which comprises a bore that extends through the frame part from the first side to the second side of the frame part, into which bore the spindle (2) of the valve is arranged in a movable manner, which valve spindle is fitted to be moved with an adjustment means (3) that is connected to the frame part (1) and can be rotated with respect to the frame part, which adjustment means (3) comprises an aperture, through which the valve spindle extends, in which case the adjustment means (3) comprises an internal thread part (12) that is fitted to the counterthreads (11) of the spindle part such that when the adjustment means (3) is rotated the valve spindle (2) moves along with the rise of the threads, characterized in that rolling means (8) are fitted between the frame part (1) and the adjustment means (3) and, for the rolling means, an aperture (9) or embedding into the first either frame part or adjustment means, and a rolling groove (10) into the second either frame part or adjustment means.

2. Arrangement for moving according to claim 1, characterized in that the rolling means (8) are spherical in shape.

3. Arrangement for moving according to claim 1, characterized in that the rolling means (8) are cylindrically-shaped.

4. Arrangement for moving according to claim 1, characterized in that the rolling means (8) are balls.

5. Arrangement for moving according to claim 1, characterized in that a rolling groove (10), more particularly a ball groove, is arranged into the adjustment means (3).

6. Arrangement for moving according to claim 1, characterized in that an aperture (9) or embedding is arranged into the frame part (1) for each rolling means (8).

7. Arrangement for moving according to claim 6, characterized in that the aperture (9) arranged into the frame part (1) is round in its cross-section, more particularly an aperture formed by drilling.

8. Arrangement for moving according to claim 6, characterized in the aperture (9) extends from the outer surface of the frame part (1) to the inner surface of the frame part.

9. Arrangement for moving according to claim 1, characterized in that the rolling means (8) extends from the outer surface of the valve spindle (2) through the aperture (9) of the frame part to the rolling groove (10) of the adjustment means when the arrangement for moving is in the operating position.

10. Valve that comprises an arrangement for moving the spindle of the valve according to claim 1.

11. Arrangement for moving according to claim 2, characterized in that the rolling means (8) are cylindrically-shaped.

12. Arrangement for moving according to claim 2, characterized in that the rolling means (8) are balls.

13. Arrangement for moving according to claim 3, characterized in that the rolling means (8) are balls.

14. Arrangement for moving according to claim 2, characterized in that a rolling groove (10), more particularly a ball groove, is arranged into the adjustment means (3).

15. Arrangement for moving according to claim 3, characterized in that a rolling groove (10), more particularly a ball groove, is arranged into the adjustment means (3).

16. Arrangement for moving according to claim 4, characterized in that a rolling groove (10), more particularly a ball groove, is arranged into the adjustment means (3).

17. Arrangement for moving according to claim 2, characterized in that an aperture (9) or embedding is arranged into the frame part (1) for each rolling means (8).

18. Arrangement for moving according to claim 3, characterized in that an aperture (9) or embedding is arranged into the frame part (1) for each rolling means (8).

19. Arrangement for moving according to claim 4, characterized in that an aperture (9) or embedding is arranged into the frame part (1) for each rolling means (8).

20. Arrangement for moving according to claim 5, characterized in that an aperture (9) or embedding is arranged into the frame part (1) for each rolling means (8).
